(19) United States
(12) Patent Application Publication
(10) Pub. No.: US 2015/0089510 A1
(43) Pub. Date: Mar. 26, 2015

(54) DEVICE, SYSTEM, APPARATUS, METHOD AND PROGRAM PRODUCT FOR SCHEDULING

(71) Applicant: Kabushiki Kaisha Toshiba, Minato-ku (JP)

(72) Inventor: Yasuyuki KOZAKAI, Kawasaki (JP)

(73) Assignee: Kabushiki Kaisha Toshiba, Minato-ku (JP)

(21) Appl. No.: 14/482,025

(22) Filed: Sep. 10, 2014

(30) Foreign Application Priority Data
Sep. 24, 2013 (JP) 2013-196961

(51) Int. Cl. G06F 9/48

(52) U.S. Cl. CPC G06F 9/485; G06F 2209/486
USPC 718/103

(57) ABSTRACT

A scheduling device according to embodiment may comprise a controller, a load calculator, a resource calculator. The controller may be configured to obtain an execution history of one or more tasks operating on a virtual OS. The load calculator may be configured to calculate a first resource amount required by each task based on the execution history. The resource calculator may be configured to calculate a second resource to be assigned to the virtual OS based on the first resource amount calculated for the one or more tasks.

### CROSS-REFERENCE TO RELATED APPLICATION(S)

This application is based upon and claims the benefit of priority from the Japanese Patent Application No. 2013-196961, filed on Sep. 24, 2013; the entire contents of which are incorporated herein by reference.

### FIELD

Embodiments described herein relate generally to a device, a system, an apparatus, a method and a program product for scheduling.

### BACKGROUND

Conventionally, a virtualization technology in which a plurality of OSs (operating system) are executed on a single device is known. In the visualization technology, for instance, a CPU (central processing unit) resource required for each virtual machine is automatically adjusted. Furthermore, there is a technique where a CPU resource is increased by feedback control when the CPU resource is not enough to a virtual machine.

However, even with the use of the conventional virtualization technology, there may be a case where periods where it is impossible to provide sufficient resources to virtual machines are produced.

### BRIEF DESCRIPTION OF THE DRAWINGS

FIG. 1 is a block diagram showing an outline structure example of a data processing system according to a first embodiment;

FIG. 2 is an illustration showing an execution cycle of task according to first to third embodiments;

FIG. 3 is an illustration showing a first example of execution history according to the first to third embodiments;

FIG. 4 is an illustration showing a second example of execution history according to the first to third embodiments;

FIG. 5 is an illustration showing an example of a resource amount according to the first to third embodiments;

FIG. 6 is a sequence diagram showing an operation example according to the first embodiment;

FIG. 7 is a flowchart showing an example of a method of calculating a resource amount to be assigned to a virtual OS by an orchestrator according to the first and second embodiments;

FIG. 8 is a flowchart showing an example of a method of calculating a minimum resource amount with respect to a task by the orchestrator according to the first and second embodiments;

FIG. 9 is a sequence diagram showing an operation example according to the second embodiment;

FIG. 10 is a block diagram showing an outline structure example of a data processing system according to the third embodiment; and

FIG. 11 is a sequence diagram showing an operation example according to the third embodiment.

### DETAILED DESCRIPTION

Exemplary embodiments of a device, a system, an apparatus, a method and a program product for scheduling will be explained below in detail with reference to the accompanying drawings.

### First Embodiment

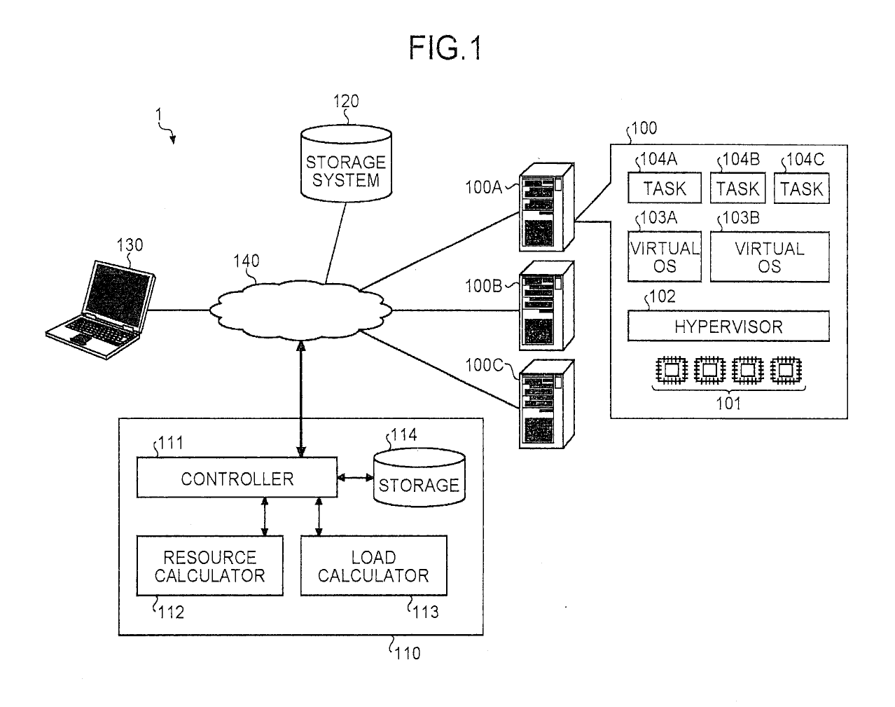

Firstly, a device, a system, an apparatus, a method and a program product for scheduling according to a first embodiment will be explained in detail with reference to the accompanying drawings. FIG. 1 shows a structure example of a data processing system according to the first embodiment. As shown in FIG. 1, a data processing system 1 has a structure in that one or more servers 100A to 100V, a scheduling device 110, a storage system 120 and a terminal 130 are connected with each other via a network 140. In the following, the scheduling device 110 may also be referred to as an orchestrator 110. When there is no necessity of distinguishing the servers 100A to 100C, they will be referred to as servers 100.

The terminal 130 is a calculator operated by an operator. The operator inputs instructions for booting, testing, terminating, or the like, virtual machines to the orchestrator 110 using the terminal 130. The instructions inputted to the terminal 130 are transmitted to the orchestrator 110 via the network 140.

The orchestrator 130 is a virtual OS controller configured to control virtual OSs, or the like, operating on the servers 100. For example, the orchestrater 110 creates a message including commands for booting, testing, terminating, or the like, virtual OSs in accordance with a message received from the terminal 130. The created message is transmitted to the servers 100 via the network 140.

The orchestrator 110, if needed, creates a message including a command for transferring a virtual OS from a certain server 100 (hereinafter referred to as a source server) to other server 100 (hereinafter referred to as a destination server), and transmits the message to the servers 100. Furthermore, the orchestrator 110 acquires an execution cycle of task executed on a virtual OS from each server 100.

Each server 100 may be constructed from one or more CPU cores; (processors) 101, a hypervisor 102, zero or more virtual OSs 103A to 103B, and zero or more tasks 104A to 104C. In the following, when there is no necessity of distinguishing the virtual OSs 103A to 103B, they will be referred to as virtual OSs 103. Also, when there is no necessity of distinguishing the tasks 104A to 104C, they will be referred to as tasks 104. On a single virtual OS 103, zero or more tasks 104 are executed. In the example shown in FIG. 1, the task 104A is executed on the virtual OS 103A, and the tasks 104B and 104C are executed on the virtual OS 103B.

The virtual OS 103 is executed, for example, by a server 100 acquiring an image file of the virtual OS 103 from the storage system 120 via the network 140 and then executing the image file. The hypervisor 102 is software or a circuit configured to schedule the virtual OSs 103 and emulate a computer. The virtual OSs 103 are operating systems executed on the CPU cores 101. The tasks 104 are software executing processes periodically.

The orchestrator 110 is constructed from a controller 111, a resource calculator 112, a load calculator 113 and a storage 114.

The load calculator 113 calculates an amount of resource (hereinafter referred to as a resource amount) required for each task executed on the virtual OSs 103 based on execution histories of the virtual OSs 103 and/or the tasks 104 acquired from the servers 100.

The resource calculator 112 calculates a minimum resource amount for each virtual OS 103 using a resource required for executing each task 104.

The controller 111 creates a message including commands for booting, testing, terminating, or the like, virtual OSs 103 in accordance with a message received from the terminal 130, and transmits the created message to the servers 100. Furthermore, the controller 111 creates a message including commands for transferring the virtual OSs 103 from a source server 100 to a destination server 100 as necessary, and transmits the created message to the destination server 100. Moreover, the controller 111 creates a message including a resource amounts assigned to the virtual OSs 103, and transmits the created massage to the servers 100. The resource amounts assigned to the virtual OSs 103 can also be included in a message for instructing to boot or transfer the virtual OSs 103.

The storage 114 stores the execution histories of task and the resource amounts assigned to the virtual OSs 103.

The orchestrator 110 instructs the servers 100 to test the virtual OSs 103, and acquires results of the test from the servers 100. The result of test may include execution histories of one or more tasks 104 executed on the virtual OSs 103, for instance.

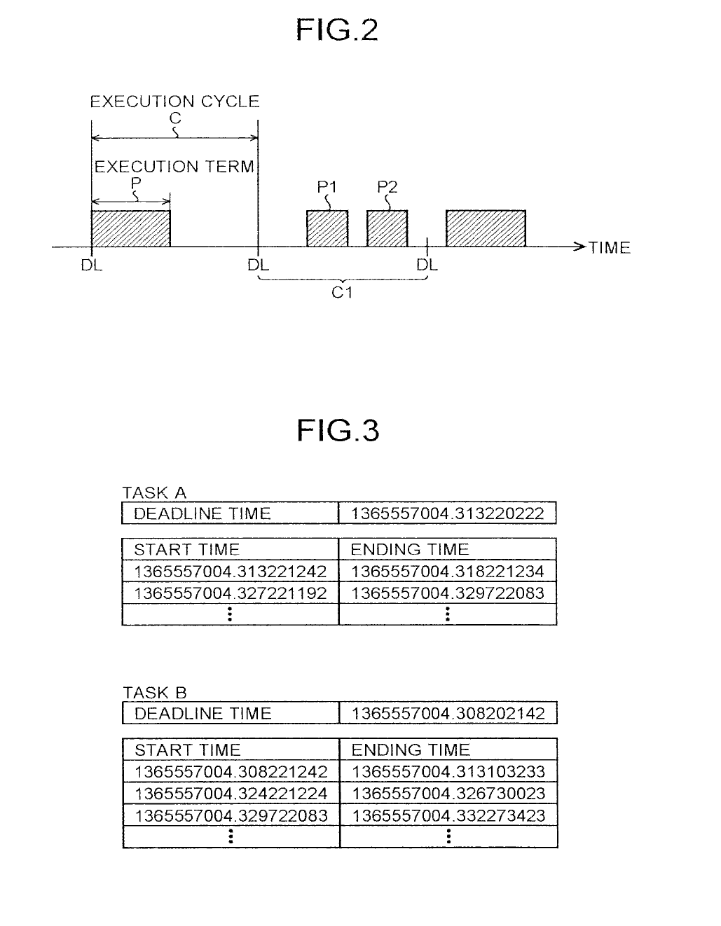

Here, an example of execution cycle of task is shown in FIG. 2. As shown in FIG. 2, the tasks 104 should finish one process until each preset periodic deadline DL. The deadlines DL are arranged at regular intervals, and an interval thereof is the execution cycle C of task. A term for executing each task 104 in one execution cycle C is an execution term P of task. There is no necessity of executing each task 104 sequentially until a single process is finished while it is also possible to execute each task 104 intermittingly over a plurality of terms. For example, as can be understood from an execution cycle C1 in FIG. 2, each task 104 can be executed during two distinct, terms P1 and P2.

FIG. 3 shows an example of the execution history in a case where one of the CPU cores 101 executes tasks A and B. The execution history of task is represented by terms in which the CPU core 101 executes the tasks A and B.

The execution histories of the tasks A and B shown in FIG. 3 include one or more execution terms, respectively. FIG. 3 shows an example where the CPU core 101 executes the tasks A and B alternately. Therefore, FIG. 3 shows an example in which the execution terms of the tasks A and B are intermissive, respectively.

The execution term P of task is represented by start times and ending times. Each start time is a time when the CPU core 101 starts or restarts execution of the task A or B. Each ending time is a time when the CPU core 101 terminates or interrupts the execution of the task A or B.

These start times and ending times are represented by an elapsed time from Unix© Epoch, respectively, for instance. For example, in FIG. 3, an initial start time of the task A is a time when 1365557004.313221242 seconds are passed from Unix© Epoch.

The start time and the ending time are not limited to a format represented by elapsed times, and they can be represented by any format. For example, the start time and the ending time can be represented by a time in an arbitrary time zone, and they can also be represented by the UTC (coordinate universal time), the TAI (international atomic time), the GMT (Greenwich civil time), or the like. Furthermore, the start time and the ending time can be represented by an elapsed time from booting or resetting a timer. A unit of the start time and the ending time is not limited to a second bit, and a time shorter than a second can be applied to the unit of the start time and the ending time. Furthermore, instead of the ending time, a term from the starting time to an ending point can be used.

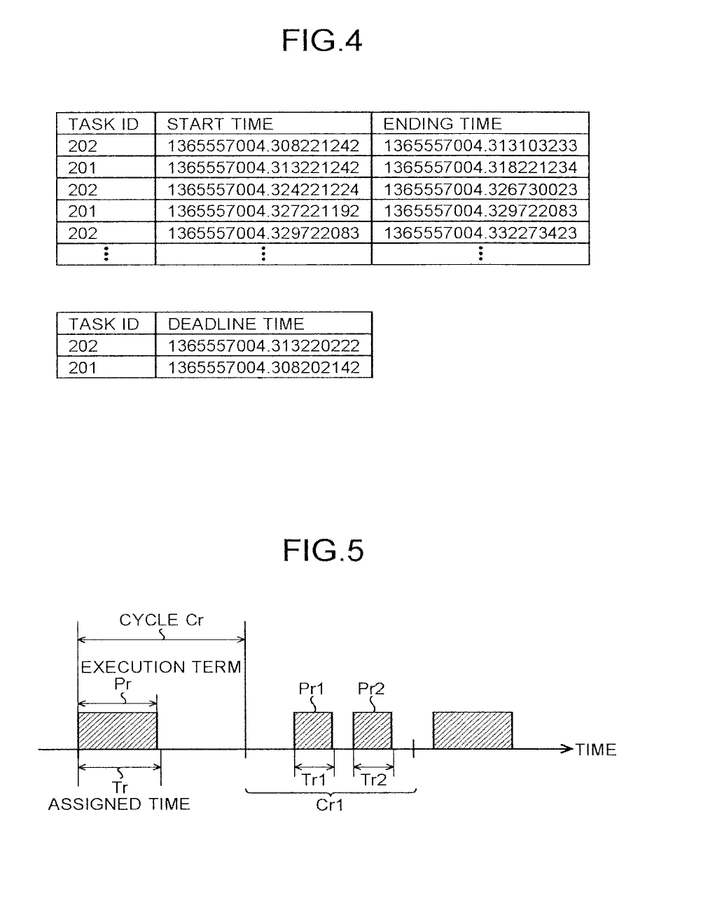

As shown in FIG. 3, there is no necessity of managing the execution history by each task. For example, as shown in FIG. 4, the execution history can be managed using a format in which the execution terms of the tasks A and B are listed with identifiers for identifying the tasks A and B (hereinafter referred to as task IDs). In the execution history, one or more deadlines DL are included for every task.

The orchestrator 110 calculates resources to be assigned to the virtual OSs 103 using the execution histories. Furthermore, the orchestrator 110 transmits a message including the calculated resources to the servers 100.

Each server 100 is a computer executing one or more virtual OSs 103. The servers 100 boot, test and terminate the virtual OSs 103 in accordance with messages received from the orchestrator 110. Furthermore, the servers 100 adjust resources to be assigned to the virtual OSs 103 in accordance with the message received from the orchestrator 110.

Here, a definition of resource will be explained using FIG. 5. In the explanation, a resource is a CPU resource or a network resource, for instance. However, the resource is not limited to those just mentioned but can be any resource as long as a resource time-shared by a plurality of virtual OSs or tasks can be applied. An execution cycle is generalized into a cycle for using a resource, and an execution term is generalized into a term for using a resource.

A resource is assigned to tasks or virtual OSs. The resource is defined by an assigned cycle Π and an assigned time for each cycle Θ. That is, a task with a resource (Π, Θ) can use a resource during a total term of Θ for every assigned cycle Π. Although the resource is similar to a pair of an execution cycle and a total execution term, they have different concept. A task does not necessarily consume all of the assigned resource. Therefore, the execution cycle of the task with the assigned resource (Π, Θ) does not necessarily have to be Π, and the total execution term, does not necessarily have to be Θ. A definition of resources assigned to virtual OSs is the same as the definition of the resource assigned to tasks. When the resource (Π, Θ) is assigned to a virtual OS, the virtual OS can maize either task use a CPU core during a term Θ for every cycle Π. Units of the assigned cycle Π and the assigned time Θ can be defined as a shortest time capable of being assigned to virtual OSs, for instance.

FIG. 5 shows an example of a case where the assigned cycle Cr and the assigned time Tr of the CPU resource assigned to the virtual OS 103 shown in FIG. 1 are 100 milliseconds and 50 milliseconds, respectively. In such case, the virtual OS 103 can use the CPU core 101 during 50 milliseconds for every 100 milliseconds. The term during the CPU core 101 executes the task 104 on the virtual OS 103 is included in a term during the CPU core 101 is assigned to the virtual OS 103.

The assigned time Tr of the resource assigned to the virtual OS 103 does not necessarily need to be successive. For example, in the example shown in FIG. 5, the assigned time in the term Cr1 is divided into a first assigned time Tr1 and a second assigned time Tr2. In such case, a total time of the first assigned rime Tr1 and the second assigned time Tr2 should be the assigned time Tr (50 milliseconds). An execution time of the virtual OS 103 in the term Cr1 is a total time of an execution time Pr1 in the first assigned time Tr1 and an execution time Pr2 in the second assigned time Tr2. The total time (Pr1+Pr2) is equal to an execution time in a case where the virtual OS 103 is executed successively.

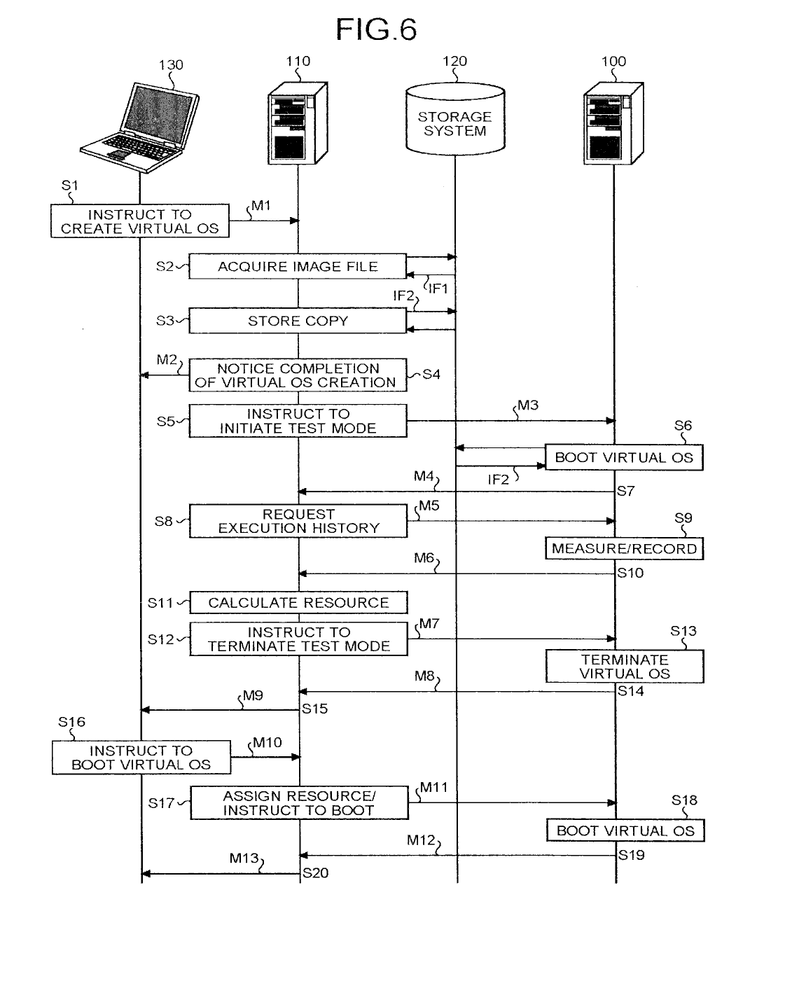

Next, an operation of the data processing system 1 according to the first embodiment, will be described in detail with reference to the accompanying drawings. FIG. 6 is a sequence diagram showing an operation example of the data processing system according to the first embodiment. In FIG. 6, a case where an operator creates an image file of the virtual OS 103B and the virtual OS 103B is booted on the server 100 is exampled.

As shown in FIG. 6, firstly, when an operator inputs an instruction for creating the virtual OS 103B to the terminal 130, the terminal 130 transmits a message M1 including the instruction for creating the virtual OS 103B to the orchestrator 110 (step S1). The message M1 includes at least an identifier for identifying the image file of the virtual OS 103B.

Then, the controller 111 of the orchestrator 110 acquires an image file IF1 corresponding to the identifier included in the message M1 from the storage system 120 (step S2). Furthermore, the controller 111 stores a copy of the image file IF1 in the storage system 120 (step S3). Then, the orchestrator 110 notices a message M2 indicating a completion of creation of the virtual OS 103B to the terminal 130 (step S4).

Next, the orchestrator 110 transmits a message M3 including a command for booting the virtual OS 103B included in the image file IF2 in a test mode to the server 100 (step S5). The message M3 includes an identifier for identifying the image file IF2 of the virtual OS 103B.

Next, the server 100 boots the virtual OS 103B included in the image file IF2 based on the received message M3 (step, S6), and then, when the virtual OS 103B is booted, the server 100 transmits a message M4 indicating the completion of the booting of the virtual OS 103B to the orchestrator 110 (step S7).

In particular, in step 36, the hypervisor 102 of the server 100 acquires the image file IF2 including the virtual OS 103B from the storage system 120 using the identifier included in the received message M3. Then, the hypervisor 102 selects one CPU core 101 from one or more CPU cores 101, and assigns 100% of a CPU resource of the selected CPU core 101 to the virtual OS 103B. That is, in step S6, an assigned cycle of the CPU resource to be assigned to the virtual OS 103B is the same as an assigned time for every cycle. And then, the selected CPU core 101 executes the virtual OS 103B and the task 104 on the virtual OS 103B. In this way, when the virtual OS 1033 is booted in the test mode, the server 100 transmits the message M4 indicating the completion of the booting to the orchestrator 110 in step S7.

Next, the orchestrator 110 transmits a message M5 indicating a request for transmission of execution histories to the server 100 (step S8). On the other hand, the server 100 measures and records execution histories of all the tasks 104 on the virtual OS 103B for a preset time (step S9), and transmits a message M6 including the recorded execution histories to the orchestrator 110 (step S10). Any manner of notification can be applied to the notification of the execution histories to the orchestrator 110 from the server 100 in step S10. For example, the virtual OS 103B can provide an API (application programming interface) in which start times and ending times are noticed from tasks 104B and 1C4C to the hypervisor 102 to the tasks 104B and 1040. In such case, the tasks 104B and 104C record a start time and an ending time, respectively, and notice the recorded start times and ending times to the hypervisor 102 via the API. The hypervisor 102 can transmit the start times and the ending times to the orchestrator 110 as the execution histories. It is also possible that the virtual. OS 103B records the start times of the ending times of the tasks 104B and 104C, and the hypervisor 102 transmits the recorded start times and ending times to the orchestrator 110 as the execution histories. Furthermore, instead of passing through the hypervisor 102, the task 104B, 104C or the virtual OS 103B can directly transmit the execution histories to the orchestrator 110.

Next, the orchestrator 110 calculates a CPU resource to be assigned to the virtual OS 103B based on the execution history included in the received message M6 (step S11). The calculated resource amount to be assigned to the virtual OS 1033 is stored in the storage 114, for instance.

Next, the controller 111 of the orchestrator 110 transmits a message M7 for instructing to terminate the test mode to the server 100 (step S12). In response to this, the server 100 stops the virtual OS 103B in accordance with the instruction for terminating the test mode included in the message M7 (step S13). Then, the server 100 transmits a message M8 for noticing the completion of the termination of the virtual OS 103B to the orchestrator 110 (step S14). The orchestrator 110 transmits a message M9 for noticing the termination of the test mode to the terminal 130 (step S15).

After the terminal receives the message 149, when an operator inputs an instruction for booting the virtual OS 103B to the terminal 130, the terminal 130 transmits a message M10 indicating a booting of the virtual OS 103B to the orchestrator 110 (step S16). The controller 111 of the orchestrator 110 receiving the message M10 acquires a resource amount to be assigned to the virtual OS 103B from the storage 114, and transmits a message M11 including the instruction for booting the virtual OS 103B and the acquired resource amount (step S17).

Next, the server 100 assigns a CPU resource to the virtual. OS 103B in accordance with the resource amount included in the message M11 and boots the virtual OS 103B (step S18). At this time, the hyper visor 102 of the server 100 can schedule the virtual OS 103B based on a rate monotonic scheduling. Also, the hypervisor 102 can schedule the virtual OS 1033 based on an earliest deadline first. In either case, the hypervisor 102 schedules so that the CPU core 101 executes the tasks 104 on the virtual OS 103B during a time Θ2 at a maximum for every cycle Π2 while defining a resource R2 to be assigned to the virtual OS 103B as (Π2, Θ2).

Next, the server 100 transmits a message M1 indicating the completion of the booting of the virtual OS 103B to the orchestrator 110 (step S19). In response to this, the orchestrator 110 transmits a message M13 indicating the completion of the booting of the virtual OS 103B to the terminal 130 (step S20). Thereby, the operation from the execution of thee test mode directed at the calculation of the resource amounts to be assigned to the virtual OSs till the actual execution of the virtual OSs according to the first embodiment is finished.

Here, a method of calculating a resource amount in step) S11 of FIG. 6 will be described. For calculating a resource amount, the orchestrator 110 acquires execution cycles of the tasks 104B and 104C at arbitrary timing before at least step S11. However, the orchestrator 110 can acquire the execution cycle of the tasks 104B and 104C at different timings.

The orchestrator 110 can acquire the execution cycles of the task 104B on the virtual OS 103B by either method described below. For example, it is possible that an operator previously stores the execution cycle of the task 104B in the storage 114 of the orchestrator 110 shown in FIG. 1, and the resource calculator 112 of the orchestrator 110 acquires the stored execution cycle via the controller 111. Or, it is also possible that a file including the execution cycle of the task 104B is previously stored in the storage system 120, and the orchestrator 110 acquires the file via the network 140 and inputs the file to the resource calculator 112. When a provider of the virtual OS 103B distributes the file including the execution cycle of the task 104B with an image of the virtual OS 103B, it is possible to skip the process that an operator inputs the execution cycle of the task 104B.

It is also possible that the orchestrator 110 receives a message including the execution cycle of the task 104B at arbitrary timing from one server 100 and stores the execution cycle of the task 104B in the storage 114. In such case, the hypervisor 102 of the server 100 or the virtual OS 103B may describe the execution cycle of the task 104B in the message to be transmitted to the orchestrator 110. Or the task 104B may directly notice own execution cycle to the orchestrator 110. In such case, for instance, even if the execution cycle of the task 104B is changed, it is possible to skip the process that an operator inputs the execution cycle of the task 104B again.

It is also possible that the execution cycle of the task 104B is transmitted with the execution history of the task 104B by the server 100 describing the execution cycle of the task 104B in the message M6. In such case, the orchestrator 110 can acquire the execution cycle and the execution history at once. Any one of the above-described methods can be applied to a method for the orchestrator 110 acquiring the execution cycle of the task 104B.

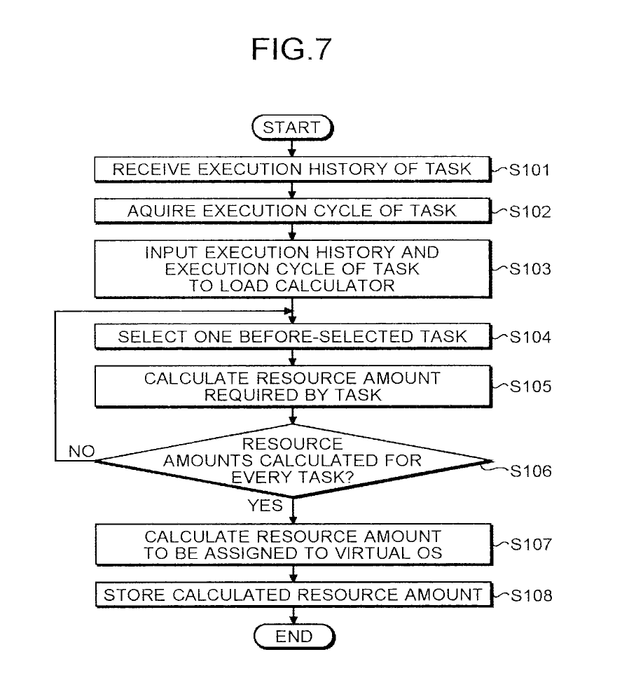

Next, a method for the orchestrator 110 calculating a resource amount to be assigned to the virtual OS 103B based on the execution cycle and the execution history of the tasks 104 on the virtual OS 103B. FIG. 7 is a flow-chart showing an operation in which the orchestrator 110 calculates a resource amount to be assigned to the virtual OS 103B. In the following explanations of an operation of the orchestrator 110 shown in FIG. 7, the task 104 indicates the tasks 104B and 104C.

As shown in FIG. 7, firstly, when the controller 111 receives a message M6 including an execution histories from the server 100 (step S101), and acquires an execution ovule of the tasks 104 (step S102), the controller 111 inputs the execution histories included in the received message M6 and the acquired execution cycles of the tasks 104 to the load calculator 113 (step S103).

The load calculator 113 acquiring the execution histories and the execution cycles of the tasks 104 selects one before-selected task from among all of the tasks 104 operating on the virtual OS 103B (step S104). The task selected by the load calculator 113 will be referred to as a task α. The load calculator 113 calculates a CPU resource amount required by the task a by analyzing the execution histories about the task a (step S105). Then, the load calculator 113 determines whether CPU resource amounts are calculated for every tasks 104 operating on the virtual OS 1033 or not (step S106), and when a task 104 of which a CPU resource amount is not calculated exists (step S106; NO), the operation returns to step S104. Thereby, with respect to every tasks 104 operating on the virtual OS 103B, a resource amount required by each task 104 is calculated.

Next, the resource calculator 112 calculates a resource amount to be assigned to the virtual OS 103B using the resource amount required by each task 104 calculated by the load calculator 113 (step S107). The controller 111 stores the resource amount to be assigned to the virtual OS 103B in the storage 114 (step S108).

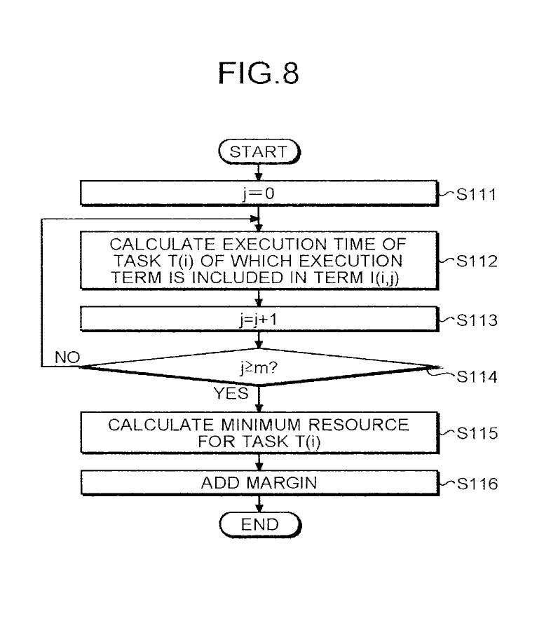

An operation example of the load calculator 113 in step S105 in FIG. 7 will be explained using FIG. 8. Although FIG. 8 shows a case where the number of the tasks 104 operating on the virtual OS 1033 is two, the number of the tasks 104 operating on the virtual OS 103B is unlimited. In the following, the number of the tasks 104 operating on the virtual OS 103B will be represented as n. Furthermore, a task 104 operating on the virtual OS 103B will be represented as T(i). The variable number i is an integer satisfying 0<i<n. Moreover, it is assumed that a deadline time of a task T(i) just before an earliest start time among tasks T(i) listed in the execution histories is defined as D(i, 0), and a deadline time of a task T(i) just after a latest ending time among the tasks T(i) listed in the execution histories is defined as D(i, m). Moreover, it is also assumed that a deadline time of a task T(i) included in a term from the time D(i, 0) to the time D(i, m) is defined as D(i, j) (note that j is an integer satisfying 0≦j≦m), and a term from a time D(i, j) to a time D(i, j+1) (note that 0≦j≦m−1) is defined as I (i, j).

Firstly, the load calculator 113 obtains an execution time or a total execution time when an execution term is divided) C(i, j) of a task T(i) included in each term I(i, j). In particular, the load calculator 113 sets the variable j as 0 (step S111), and calculates an execution time C(i, j) of each task T(i) of which execution term is included in a term I(i, j) (step S112). Then, the load calculator 113 increments the variable by 1 (step S113), and determines whether the incremented variable j reaches m or not (step S114). When the variable j does not reach m (step S114; NO), the load calculator 113 returns to step S112, and after that, by repeating steps S112 to S114 until the variable j reaches m, the load calculator 113 obtains the execution time C(i, j) of the task T(i) included in each term I(i, j).

Here, when a start time and an ending time of each task T (i) listed in the execution histories are defined as S(i, k) and E(i, k), respectively, the execution time C(i, j) can be calculated using the following formula (1).

C(i,j)=Σ{E(i, k)=S(i, k)} (1)

(note that E(i, k) and S(i, k) are included in the term I (i, j))

Next, the load calculator 113 obtains a minimal resource R(i) required by the task T(i) (step S115). The minimal resource R(i) required by the task T(i) can be defined based on the assigned cycle c) and the assigned time Θ(i) for each cycle. For example, the load calculator 113 can define the execution cycle of the task T(i) as the assigned cycle Θ(i).

Furthermore, the load calculator 113 can define a minimum value of the execution time C(i, j) (note that 0≦j≦m−1) as the assigned time Θ(i), and also can define a maximum value of the execution time C (i, j) (note that 0≦j≦m−l) as the assigned time Θ(i). Moreover, the load calculator 113 also can define an average value of the execution times C(i, j) (note that 0≦j≦m−1) as the assigned time Θ(i). Moreover, the road calculator 113 also can define a maximum value among (m*X) number of execution times C(i, j) selected from the execution times C(i, j) closer to the average value as the assigned time Θ(i). Here, X can be any value as long as it satisfies 0≦x≦1.

Next, the load calculator 113 obtains a new resource R1 (i) by adding a margin to the minimal resource R(i) obtained for the task T(i) (step S116). For example, the load calculator 113 defines the execution cycle of the task T (i) same with the assigned cycle Π(i) as an assigned cycle Π1 (i) of a resource R1 (i). The resource R1 (i) indicates a resource required by the task T(i).

The load calculator 113 can calculates an assigned time Θ1(i) with the margin using the following formula (2). Here, in the formula (2), ε(i) is the margin added to the resource R(i). In the formula (2), the margin ε(i) is defined by time.

Θ1 (i)=Θ(i)+ε(i) (2)

The load calculator 113 can add the margin in accordance with a rule shown in the following formula (3), for instance. In the formula (3) also, the margin ε(i) is defined by time.

In a case where Π(a)≦Π(b), ε(a)≦ε(b) (3)

Because the longer the execution cycle is, the smaller the number of the terms I included in the execution histories becomes, the execution times C(i, j) tend to disperse. Therefore, as in the formula (3), by adding greater margin ε(i) as the execution cycle becomes longer, the greater the margin ε(i) being added, it is possible to avoid a case in which a resource finally assigned to the virtual OS 103B becomes short.

Furthermore, the load calculator 113 can add the margin ε(i) in accordance with a rule shown in the following formula (4), for instance.

In a case where Θ(a)≦Θ(b), ε(a)≦ε(b) (4)

Moreover, the load calculator 113 can calculate the margin ε(i) using the following formula (5), for instance.

ε(i)=k×δ(i) (5)

In the formula (5), δ(i) is a dispersion or a standard deviation of the execution time C(i, j) (0≦j≦m−1) of the task T(i). The δ(i) can be a value calculated by subtracting a minimum value the execution times C(i, j) (0≦j≦m−1) from a maximum value of the execution times C(i, j ) (0≦j≦m−1). Furthermore, k in the formula (5) is a preset constant actual number being more than 0.

Next, an operation example of the resource calculator 112 in step S107 of FIG. 7 will be described. The resource calculator 112 may calculate a resource R2=(Π2, Θ2) using a method described in Reference 1 by J. Lee, S. Xi, S. Chen, L. T. X. Phan, C. Gill, I. Lee, C. Lu, and O. Sokolsky, “Realizing Compositional Scheduling through Virtualization”, 2012 IEEE 18th Raal Time and Embedded Technology and applications Symposium, Beijing, China, Apr. 16-19, 2012,while defining a resource R1(i) (0≦i<1) required by each task as an input, for instance, and then assign the resource R2 to the virtual OS 103.

The resource calculator 112 may calculate a new resource R3=(Π3, Θ3) by adding a margin ψ to the resource R2 calculated for the virtual OS 103B, and assign the resource R3 to the virtual OS 103B. The margin ψ is defined by time. For example, the resource calculator 112 adds the margin to the resource to be assigned to the virtual OS 103B in accordance with Π3=Π2−ψ or Θ3=Θ2+ψ. Furthermore, for example, the resource calculator 112 can define that the smaller the dispersion of the execution cycle Π(i) of each task 104 is, the greater the margin ψ is.

For example, when the virtual OS 103B uses a scheduling algorism based on a static priority such as a rate monotonic scheduling, because the smaller the dispersion of the assigned cycle Π(i) is, the greater the ratio of the assigned time Θ3 in the assigned cycle Π3, there is a high possibility that a resource of any one of the tasks T(i) may become short. Therefore, by increasing the margin ψ when the dispersion of the assigned cycle Π(i) is small, it is possible to reduce the possibility of a resource shortage of any cone of the tasks T(i).

The resource calculator 112 can decide the margin ψ so that the smaller the value calculated by subtracting a minimum execution cycle Π from a maximum execution cycle Π among the tasks T(i) operating on the virtual OS 103B is, the greater the margin ψ becomes, for instance. Thereby, it is possible to calculate the margin ψ with a calculation amount smaller than that for calculating the dispersion.

Moreover, the resource calculator 112 can arrange that a ratio of unused resource by the virtual OS 103B always becomes greater than a value Ω by calculating the margin ψ to be added to the resource R2 using the following formula (6).

Δ=1−Σ{Θ(i)/Π(i)}

ψ=Π2×(Ω−Δ) (in a case of Δ<Ω or Δ≧Ω) (6)

In the formula (6), Ω is a preset value. Δ indicates an estimate value of the unused resource by the virtual OS 103B in a case where the resource R2 is assigned to the virtual OS 103B.

In both of the above-described calculation methods of the margins ε and ψ, the margin ε or ψ can be decided based on the execution cycle or the execution time for each cycle of each task T (i).

As described above, according to the first embodiment, it is possible to provide CPU resources that is sufficient and as minimum necessary to virtual machines executing real time tasks.

In the first embodiment, because the orchestrator 110 has the function for making the server 100 actually measure execution terms of the tasks 104 operating on the virtual OS 1033 of the server 100, the orchestrator 110 can acquire an execution time for each cycle with accuracy.

Because the orchestrator 110 adds the margin to the minimum resource calculated using the execution history for each task T(i) operating on the virtual OS 103B, it is possible to prevent any one of the tasks T(i) operating on the virtual OS 103B from suffering resource shortage.

Because the orchestrator 110 decides the margin to be added to the minimum resource for the task T(i) based on the execution cycle of the task T(i), it is possible to minimalize the margin.

Because orchestrator 110 makes the margin to be added to the virtual OS where a dispersion of the execution cycle of the task (i) is greater smaller, it is possible to minimalize the margin to be added.

The orchestrator 110 has the function for instructing the server 100 to actually measure the execution term of the task T(i). Thereby, even if the server 100 is replaced with a server with a different performance, for instance, it is possible to save steps in that an operator inputs the execution time for each cycle of the task T(i).

In the first embodiment, when the minimum resource for each task T(i) operating on the virtual OS 103B is prestored in thee storage system 120 or the storage 114 of thee orchestrator 110, the orchestrator 110, the storage system 120 and the server 100 can omit steps S5 to S9 and S12 to S14 shown in FIG. 6. In such case, it is possible to shorten the time for assigning the sufficient resource to the virtual OS 103B.

The server 100 can assign a plurality of CPU cores 101 to the virtual OS 103B. In such case, in step S17 shown in FIG. 6, the orchestrator 110 can divide one or more tasks into one or more groups. Then, the orchestrator 110 can calculate a resource to be assigned to each group. The calculated resource amount for each group may be included in the massage; M11 shown in FIG. 6. Furthermore, the server 100 can execute tasks 100 belonging in the same group by a single CPU core 101.

In the first embodiment, a measurement period for the server 100 measuring the execution term of the tasks 104 can be a preset period of time. The measurement period can also be a preset, number of times. The measurement period can also be a period until the dispersion of the execution time for each execution cycle becomes a preset value.

### Second Embodiment

Next, a device, a system, an apparatus, a method and a program product for scheduling according to a second embodiment will be explained in detail with reference to the accompanying drawings. In the first embodiment, the case where the virtual OS 103 has the test mode is exampled. In the second embodiment, a case where the virtual OS 103 does not have a test mode will be exampled. In the second embodiment, at an arbitrary timing daring the virtual OS 103 is operating, the orchestrator 110 automatically calculates a minimum resource to be assigned to the virtual OS 103.

A structure of a data processing system according to the second embodiment can be the set me as the structure of the data processing system 1 explained in the first embodiment using FIG. 1, and the redundant explanations thereof will be omitted.

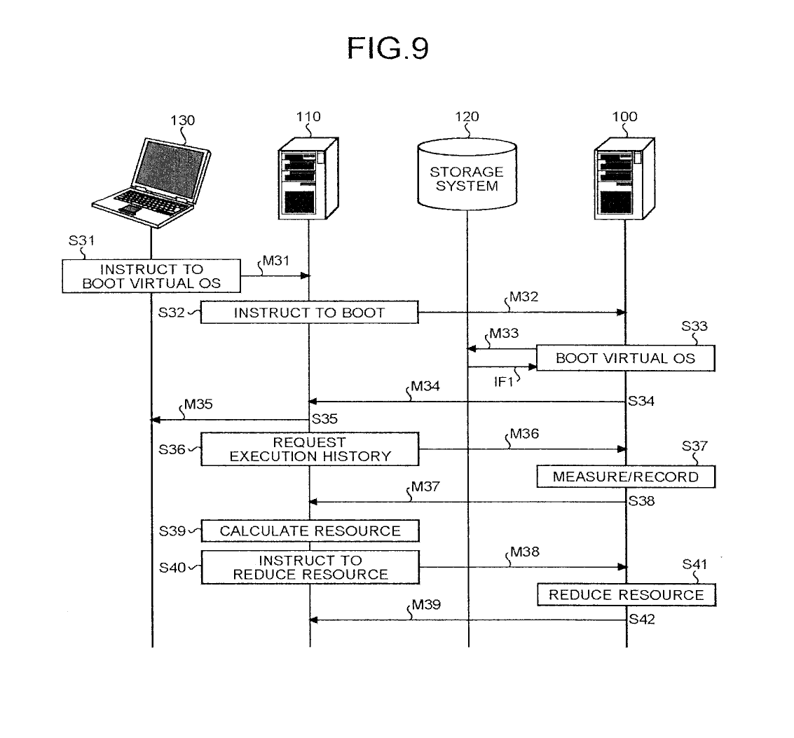

FIG. 9 is a sequence diagram showing an operation example of a data processing system according to the second embodiment. In the following explanation of the operation of the data processing system according to the second embodiment, it is assumed that the image file of the virtual OS 103B shown in FIG. 1 is stored in the storage system 120.

As shown in FIG. 9, firstly, when an operator inputs a boot instruction of the virtual OS 103B stored in the storage system 120 to the terminal 130, the terminal 130 transmits a message M31 including an instruction for booting the virtual OS 103B (step S31). In response to this, the orchestrator 110 transmits a message 1432 including the boot instruction of the virtual OS 1033 to the server 100 (step S32). The messages M31 and M32 include at least an identifier for identifying the image file IF1 of the virtual OS 1033, respectively. Furthermore, the message M32 may include an instruction for assigning a sufficient resource amount to the virtual OS 103B. The sufficient resource amount may be a CPU resource for a single CPU core, for instance. In such case, an assigned cycle of a resource assigned to the virtual OS 1033 is equal to an assigned time of the resource assigned to the virtual OS 1033.

Next, the server 100 boots the virtual OS 103B included in the image file IF1 based on the received message M32 (step S33), and then, when the virtual OS 103B is booted, the server 100 transmits a message M34 indicating a completion of the booting to the orchestrator 110 (step S34).

In particular, in step S33, the server 100 transmits a message M33 for requiring the image file IF1 of the virtual OS 103B to the storage system 120. In response to this, the storage system 120 reads out the required image file IF1, and transmits the file IF1 to the server 100.

Furthermore, in step S33, the server 100 assigns a CPU resource to the booted virtual OS 103B. For example, the server 100 assigns a CPU resource for a single CPU core to the virtual OS 103B. In such case, because it is possible that the virtual OS 103B occupies a single CPU core, the virtual OS 1030 or tasks 104B and 104C operating on the virtual OS 103B can use the CPU core at any time. Here, an assigned cycle and an assigned time for each cycle of the CPU resource assigned to the virtual OS 103B can be the same. After that, the server 100 boots the virtual OS 103B by executing a program cord of the virtual OS 1033 included in the image file IF1.

After that, the orchestrator 110 which receives the message M32 indicating the completion of the booting of the virtual OS 103B from the server 100 transmits a message M35 indicating the completion of the booting of the virtual OS 1033 to the terminal 130 (step S35).

After the virtual OS 103B is booted and a certain period of time is passed, the orchestrator 110 transmits a message M36 indicating a request for transmission of execution histories to the server 100 (step S36). In response to this, the server 100 measures execution histories of all of the tasks 104 executed on the virtual OS 103B during a specific period of time and records the measured execution histories (step S37), and transmits a message M37 including the recorded execution histories to the orchestrator 110 (step S38). The orchestrator 110 received the execution histories calculates a resource amount to be assigned to the virtual OS 1033 (step S39).

The operations of the orchestrator 110 and the server 100 in steps 336 to S39 are the same as the operations shown in steps S8 to S11 of FIG. 6.

Next, the orchestrator 110 transmits a message M38 indicating a reduction of the resource amount of the virtual CS 103B to the server 100 (step 340). The message M38 includes an assigned cycle and an assigned time for each cycle of the CPU resource of the virtual OS 103B.

Next, the server 100 reduces the resource amount to be assigned to the virtual OS 103B in accordance with the assigned cycle and the assigned time for each cycle included in the message M38 (step S41). After that, the server 100 transmits a message M39 indicating a completion of the reduction of the resource amount to the orchestrator 110 (step S42).

As described above, according to the first embodiment, it is possible to provide CPU resources that is sufficient and as minimum necessary to virtual machines executing real time tasks.

Furthermore, in the second embodiment, the orchestrator 110 automatically calculates the minimum, resource to be assigned to the virtual OS 103B at an arbitrary timing during the virtual OS 103B is operating. Therefore, an operator can input an instruction for creating the virtual OS 103B before the virtual OS 103B is booted without waiting a completion of measurement, of execution histories of all of the tasks 104 operating on the virtual OS 103B.

In the second embodiment, when the minimum resource for each task operating on the virtual OS 103B is prestored in the storage system 120 or the storage 114 of the orchestrator 110, the orchestrator 110, the storage system 120 and the server 100 can omit steps S36 to S38 shown in FIG. 6. In such case, it is possible to shorten the time for assigning the sufficient resource to the virtual OS 103B.

The server 100 can assign a plurality of CPU cores 101 to the virtual OS 103B. In such case, in step S39 shown in FIG. 9, the orchestrator 110 can divide one or more tasks into one or more groups. Then, the orchestrator 110 can calculate a resource to be assigned to each group. The calculated resource amount for each group may be included in the massage M38 shown in FIG. 9. Furthermore, the server 100 can execute tasks 100 belonging in the same group by a single CPU core 101.

In the second embodiment, a measurement period for the server 100 measuring the execution term of the tasks 104 can be a preset period of time. The measurement period can also be a preset number of times. The measurement period can also be a period until the dispersion of the execution time for each execution cycle becomes a preset value. In such case, it is possible to reduce the margin ε or Ψ added to the resource to be assigned to the virtual OS 103B.

Furthermore, in the second embodiment, the orchestrator 110 can execute the processes from step S36 to step S42 twice or more. At this time, an arbitrary period of time can be arranged between iterations of the processes. In such case, the server 100 can increase the resource to be assigned to the virtual OS 103 before step S37.

### Third Embodiment

Next, a device, a system, an apparatus, a method and a program product for scheduling according to a third embodiment will be explained in detail with reference to the accompanying drawings. In the first and second embodiments, the device (the orchestrator 110) for calculating the resource amount differs from the device (the server 100) for actually assigning the resource to the virtual OS 103B. In the third embodiment, the server 100) being a server executing the virtual OS 103B calculates the resource amount to be assigned to the virtual OS 103B.

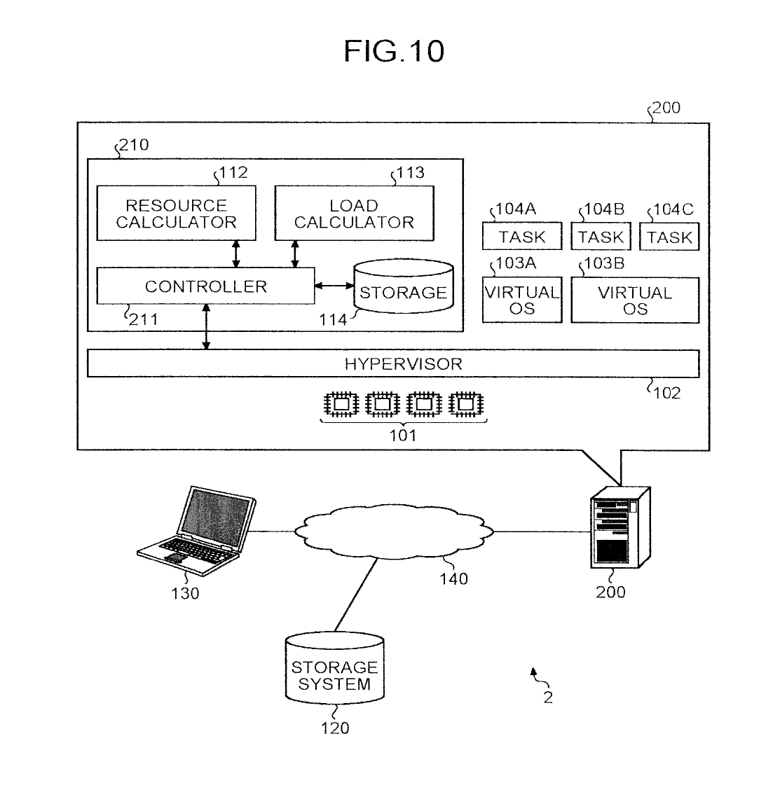

FIG. 10 shows a structure example of a data processing system according to the third embodiment. As shown in FIG. 10, a data processing system 2 according to the third embodiment has a structure in that one or more servers 200, the storage system 120 and the terminal 130 are connected with each other via the network 140. However, in FIG. 10, the servers 200 does not have to be connected to the network 140, in is also possible that the servers 200 are not connected to the network 140.

In FIG. 10, each server 200 has the tasks 104A to 104C, the virtual OSs 103A and 103B, the hypervisor 102 and the CPU cores 101. Structures and operations thereof can be the same as those of the tasks 304, the virtual OS 103, the hypervisor 102 and the CPU cores 101 exampled in the first or second embodiment.

Each server 200 further has a resource assignor 210. The resource assignor 210 is a program for realizing the functions of the orchestrator 110, for example, and the resource assignor 210 has the resource calculator 112, the load calculator 113, the storage 114 and a controller 211. Structures and operations of the resource calculator 112, the load calculator 113 and the storage 114 can be the same as those of the resource calculator 112, the load calculator 113 and the storage 114 exampled in the first or second embodiment. The controller 211, in contrast to the controller 111, directly communicates with the hypervisor 102 inside the server 200.

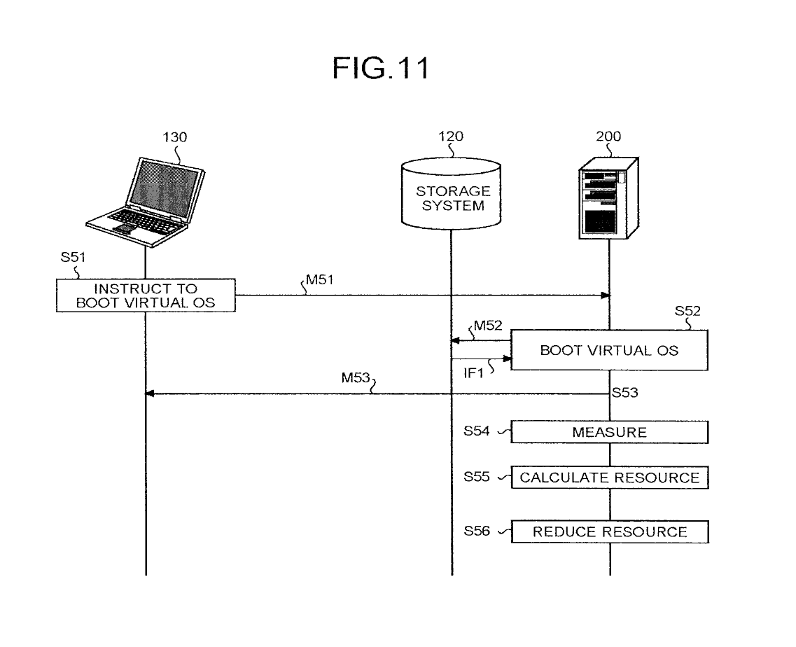

Next, an operation example of the data processing system 2 according to the third embodiment will be described with reference to FIG. 11. As shown in FIG. 11, firstly, when an operator inputs an instruction for booting the virtual OS 103B stored in the storage system 120 to the terminal 130, the terminal 130 transmits a message M51 including the instruction for booting the virtual OS 103B to the server 200 (step S51). The message M51 includes at least an identifier for identifying the image file IF1 of the virtual OS 103B.

Next, the controller 211 of the server 200 boots the virtual OS 103B included in the image file IF1 in accordance with the received message M51 (step S52), and then, when the virtual OS 103B is booted, the server 200 transmits a message M53 indicating a completion of the booting to the terminal (step S53).

In particular, in step 352, the server 200 transmits a message M52 for requiring the image file TFT of the virtual OS 103B to the storage system 120. In response to this, the storage system 120 reads out the required image file IF1, and transmits the file IF1 to the server 200.

Furthermore, in step S33, the server 200 assigns a CPU resource to the booted virtual OS 1033. For example, the server 200 assigns a CPU resource for a single CPU core to the virtual OS 1033. In such case, because it is possible float the virtual OS 1033 occupies a single CPU core, the virtual OS 103B or tasks 104 operating on the virtual OS 103B can use the CPU core at any time. Here, an assigned cycle and an assigned time tor each cycle of the CPU resource assigned to the virtual OS 103B can be the same. After that, the server 200 boots the virtual OS 103B by executing a program cord of the virtual OS 103B included in the image

Next, the server 200 measures an execution history of each task 104 operated on the virtual OS 103B (step S54). In steps S54, the controller 211 of the server 200 transmits a message for requiring the execution histories to the hypervisor 102. In response to this, the hypervisor 102 measures a start, time and an ending time of each task 104 on the virtual OS 1033. And then, the hypervisor 102 notices the execution histories to the controller 211. In step S54, instead of the hypervisor 102, the virtual OS 103B or the task 104 on the virtual OS 103B can measure the starting time and the ending time.

Next, the resource assignor 210 of the server 200 calculates a resource amount to be assigned to the virtual OS 1033 (step S55). Operations of the load calculator 113 and the resource calculator 112 in step S55 can be the same as those of the load calculator 113 and the resource calculator 112 in step S11 of FIG. 6.

Next, the controller 211 of the server 200 reduces the resource amount to be assigned to the virtual OS 1033 (step 336). An operation of step 356 can be the same as that of step S51 in FIG. 9.

As described above, according to the first embodiment, it is possible to provide CPU resources that is sufficient and as minimum necessary to virtual machines executing real time tasks.

In the first to third embodiments, although the server 100 or 200 assigns a resource of a single CPU core 101 to the virtual OS 103B, when it is obvious that a resource amount smaller than that of a resource of a single CPU core 101 is sufficient for the virtual OS 103B, it is possible to assign the resource smaller than that of a resource of a single CPU core 101 to the virtual OS 103B.

For example, the orchestrator 110 or the resource assignor 210 can assign an assigned time for each cycle shorter than the assigned cycle to the virtual OS 103B. Thereby, because there is no necessity of securement of a resource corresponding to a single CPU core, it is possible to increase candidates of the server 100 or 200 booting the virtual OS 103B.

In the first to third embodiments, the storage system 120 is not a required component. When thee steerage system 120 is omitted, the image file IF2 or IF1 of the virtual OS 103B in one of the first to third embodiments may be stored in the server 100 or 200.

Furthermore, in the first to third embodiment, the server 100 or 200 can have an interface fear directly operating a boot, of the virtual OS 103B by an operator. In such case, it is possible to avoid the necessity of remote access to the server 100 using the terminal 130 by the operator, it is possible, to omit the terminal 130.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from tree spirit of the inventions. The accompanying claims and their equivalents are intended to cover such forms or modifications as would fall within the scope and spirit, of the inventions.

What is claimed is:

1. A scheduling device comprising:
a controller configured to obtain an execution history of one or more tasks operating on a virtual OS;
a load calculator configured to calculate a first resource amount required by each task based on the execution history; and
a resource calculator configured to calculate a second resource to be assigned to the virtual OS based on the first resource amount calculated for the one or more tasks.

2. The device according to claim 1, wherein
the controller is further configured to obtain an execution cycle of the one or more tasks, and
the load calculator is further configured to calculate an execution time for each cycle of each task based on the execution history, and calculate the first resource amount required by each task based on the execution time for each cycle.

3. The device according to claim 1, wherein
the execution history includes a start time and an ending time of each task, and
the load calculator is further configured to calculate the execution time for each cycle based on the start time and the eliding time of each task.

4. A scheduling device comprising:
a load calculator configured to obtain a first resource amount required by each of one or more tasks operating on a virtual OS; and
a resource calculator configured to calculate a second resource amount to be assigned to the virtual OS based on the first resource amounts,
wherein the load calculator is further configured to calculate the first resource amount by adding a first margin depending on en execution cycle of an execution time for each cycle to a third resource amount being a minimum resource amount required by each cask.

5. The device according to claim 4, wherein the load calculator is farther configured to calculate the first margin using at least one of a time length of the execution cycle, a time length of the execution time for each cycle, a dispersion of the execution cycle, a standard deviation of the execution cycle, and a value calculated by subtracting a minimum value from a maximum value among execution times for each cycle of the one or more tasks.

6. The device according to claim 4, wherein the load calculator is further configured to add the first margin greater than the execution time for each cycle included in the third resource amount calculated for a task with a long execution cycle.

7. The device according to claim 4, wherein the load calculator is further configured to calculate a third resource amount using the first resource amount, and calculate the second resource amount by adding a second margin depending on an execution cycle of an execution time for each cycle of each task to the third resource amount.

8. The device according to claim 7, wherein the resource calculator is further configured to calculate the second margin using at least a dispersion of the execution cycle of the one or more tasks, a standard deviation of the execution cycle, and a value calculated by subtracting a minimum value from a maximum value among execution times for each cycle of the one or more tasks.

9. The device according to claim 7, wherein the resource calculator is further configured to add the second margin so that the smaller the dispersion of the execution cycle of the one or more tasks is, the greater the second margin with respect to the third resource becomes.

10. A data processing system comprising:
the scheduling device according to claim 1; and
a server connected no the scheduling device via a certain network and configured to execute the virtual OS,
wherein the controller is further configured to transmit a first message for requiring a transmission of the execution history to the server, receive a second message including the execution history from the server, and transmit a third message including the second resource amount calculated by the resource calculator to the server, and
the server is further configured to, when receiving the first message, obtain the execution history by measuring the one or more tasks, transmit the second message including the measured execution history to the scheduling device, and reduce a resource amount assigned to the virtual OS based on the second resource amount included in the receive third message.

11. The system according to claim 10, wherein
the controller is further configured to transmit a fourth message including a third resource amount before transmitting the first message to the server, and
the third resource amount is equal to or greater than at least the second resource amount.

12. A data processing device comprising:
the scheduling device according to claim 1; and
one or more computers configured to execute the virtual OS,
wherein the controller is further configured to assign the second resource amount calculated by the resource calculator to the virtual OS.

13. A scheduling method including:
obtaining an execution history of: one or more tasks operating on a virtual OS;
calculating a first resource amount required by each task based on the execution history; and
calculating a second resource amount to be assigned to the virtual OS based on the first resource amount calculated for the one or mere tasks.

14. A scheduling method including:
calculating a first resource amount being a minimum resource amount required by the one ox: more tasks operating on the virtual OS;
calculating a second resource amount required by the one or more tasks by adding a margin depending on an execution cycle or an execution time for each cycle of each task to the first resource; and
calculating a second resource amount to be assigned to the virtual OS base on the second resource amount.

15. A non-transitory computer-readable program product storing instructions for letting a computer processor schedule an assignment of resources to a virtual OS executing one or more tasks, the instructions including:
obtaining an execution history of one or more tasks operating on a virtual OS;
calculating a first resource amount required by each task based on the execution history; and
calculating a second resource amount to be assigned to the virtual OS based on the first resource amount calculated for the one or more tasks.

16. A non-transitory computer-readable program product storing instructions for letting a computer processor schedule an assignment of resources to a virtual OS executing one or more tasks, the instructions including:
calculating a first resource amount being a minimum resource amount required by the one or more tasks operating on the virtual OS;
calculating a second resource amount required by the one or more tasks by adding a margin depending on an execution cycle or an execution time for each cycle of each task to tine first resource; and
calculating a second resource amount to be assigned to the virtual OS base on the second resource amount.
